(19) United States
(12) Patent Application Publication
(10) Pub. No.: US 2021/0271980 A1
(43) Pub. Date: Sep. 2, 2021

(54) DETERMINISTIC DECODER VARIATIONAL AUTOENCODER

(71) Applicant: INSILICO MEDICINE IP LIMITED, Hong Kong (HK)

(72) Inventors: Daniil Polykovskiy, Moscow (RU); Aleksandrs Zavoronkovs, Pak Shek Kok (HK)

(21) Appl. No.: 17/189,017

(22) Filed: Mar. 1, 2021

Related U.S. Application Data
(60) Provisional application No. 62/984,172, filed on Mar. 2, 2020.

(51) Int. Cl. G06N 3/08; G06N 3/04

(52) U.S. Cl. CPC G06N 3/088; G06N 3/0454

(57) ABSTRACT

A model of a deterministic decoder VAE (DD-VAE) is provided. The DD-VAE has evidence lower bound derived, and a convenient approximation can be proposed with proven convergence to optimal parameters of a non-relaxed objective. The invention introduces bounded support distributions as a solution thereto. Experiments on multiple datasets (synthetic, MNIST, MOSES, ZINC) are performed to show that DD-VAE yields both a proper generative distribution and useful latent codes. A computer-implemented method of generating objects with a deterministic decoder variational autoencoder can include: providing a model configured as a deterministic decoder variational autoencoder; inputting object data into a stochastic encoder of the deterministic decoder variational autoencoder; generating latent codes in the latent space with the encoder; providing the latent codes from the latent space to a decoder, wherein the decoder is configured as a deterministic decoder; generating decoded objects with the decoder; and generating a report that identifies the decoded object.

### CROSS-REFERENCE TO RELATED APPLICATIONS

This patent application claims priority to U.S. Provisional Application No. 62/984,172 filed Mar. 2, 2020, which provisional is incorporated herein by specific reference in its entirety.

### BACKGROUND

### Field

The present disclosure relates to variational autoencoder with a deterministic decoder for sequential data that selects the highest scoring tokens instead of sampling.

### Description of Related Art

Variational Autoencoders (VAE) are machine learning models that learn a distribution of objects (such as molecules). Variational Autoencoders contain two neural networks, such as an encoder and a decoder. An encoder learns a mapping of an object to compressed “latent” codes, and a decoder learns to reconstruct objects from these latent codes. An important feature of VAEs is that both encoder and decoder are stochastic, i.e., encoder can map an object to different latent codes with different probabilities. Similarly, a decoder can produce different objects from the same latent code, where some objects with higher probability, some with lower. VAEs are prone to posterior collapse, which is an issue when the encoder produces the same distribution of latent codes for the majority of objects, and the decoder ignores the latent codes while generating the objects.

Variational autoencoder is an autoencoder-based generative model that provides high-quality samples in many data domains, including image generation, natural language processing, audio synthesis, and drug discovery. Variational autoencoders use stochastic encoder and decoder. An encoder maps an object x onto a distribution of the latent codes q_{ϕ}(z|x), and a decoder produces a distribution p_{θ}(x|z) of objects that correspond to a given latent code.

With complex stochastic decoders, such as PixelRNN, VAEs tend to ignore the latent codes, since the decoder is flexible enough to produce the whole data distribution p(x) without using latent codes at all. Such behavior can damage the representation learning capabilities of VAE, and cannot use its latent codes for downstream tasks.

One application of latent codes of VAEs is Bayesian optimization of molecular properties. A Gaussian process regressor has been trained on the latent codes of VAE and optimized the latent codes to discover molecular structures with desirable properties. With stochastic decoding, a Gaussian process has to account for stochasticity in target variables, since every latent code corresponds to multiple molecular structures.

### SUMMARY

In some embodiments, a model of a deterministic decoder VAE (DD-VAE) is provided. The DD-VAE can have its evidence lower bound derived, and a convenient approximation can be proposed with proven convergence to optimal parameters of a non-relaxed objective. The lossless auto-encoding is impossible with full support proposal distributions, and thereby the invention introduces bounded support distributions as a solution thereto. Experiments on multiple datasets (synthetic, MNIST, MOSES, ZINC) are performed to show that DD-VAE yields both a proper generative distribution and useful latent codes.

In some embodiments, a computer-implemented method of generating objects with a deterministic decoder variational autoencoder can include: providing a model configured as a deterministic decoder variational autoencoder; inputting object data into a stochastic encoder of the deterministic decoder variational autoencoder; generating latent codes in the latent space with the encoder; providing the latent codes from the latent space to a decoder, wherein the decoder is configured as a deterministic decoder; generating decoded objects with the decoder; and generating a report that identifies the decoded object.

In some embodiments, the method can include: the encoder mapping the object data onto a distribution of latent codes; sampling the latent codes in the latent space; inputting sampled latent codes into the deterministic decoder; the deterministic decoder mapping each latent code to a single data point; and generating a distribution of generated objects that are based on the input object data.

In some embodiments, the object data is sequence data. In some aspects, the sequence data is simplified molecular-input line-entry system (SMILES) such that the objects are molecules.

In some embodiments, the computer-implemented can include: obtaining sequence models for the object data being sequence data having sequences; defining each token of the sequences to be finite; parameterizing the sequence models as a recurrent neural network for a probability distribution over each token, given latent codes for each previous tokens; decoding a sequence from the latent codes with the highest score token to produce a reconstructed sequence; and determining the reconstructed sequence to be a correct sequence.

In some embodiments, the computer-implemented method can include: using a bounded support proposal distribution; choosing a kernel and computing a Kullback-Leibler divergence; sampling the latent codes using a rejection sampling; reparameterizing sampled latent codes to obtain a final sample; and optionally repeat sampling until obtaining acceptable final samples.

In some embodiments, the computer-implemented method can include obtaining a uniform distribution as a prior for the encoder.

In some embodiments, the computer-implemented method can include deriving Kullback-Leibler divergence for bounded support distribution for a standard Gaussian distribution and a uniform distribution as a prior for the encoder.

In some embodiments, the computer-implemented method includes: optimizing a discontinuous function by approximating it with a smooth function; defining an arg max; approximating the arg max with a smooth relaxation of an indicator function that is parameterized; and substituting the arg max with the smooth relaxation of the indicator function.

In some embodiments, the computer-implemented method includes: defining arg max equivalently; introducing a smooth relaxation of an indicator function; allowing the smooth relaxation to pointwise converge to the indicator function; substituting arg max with the smooth relaxation; and obtaining an approximation of an evidence lower bound.

In some embodiments, the computer-implemented method includes sampling being substituted for or performed by selecting latent codes using highest scoring tokens.

In some embodiments, the computer-implemented method includes: deriving a Kulback-Leibler divergence against a Gaussian distribution and a uniform distribution; or computing Kullback-Leibler divergence that encourages latent codes to be marginally distributed as p(z).

In some embodiments, the computer-implemented method can include (e.g., to train the DD-VAE):
a) initialization of a temperature parameter τ to be 0<τ<1;
b) Computing objective function using Eq. (13),

$${ℒ}_{τ} ( θ , ϕ ) = {𝔼}_{x ∼ p ( x )} [ {𝔼}_{z ∼ {q}_{ϕ}} ( z \vert x ) {\sum }_{i = 1}^{\vert x \vert} {\sum }_{s \neq {x}_{i}} log {σ}_{τ} ( {π}_{x , i , {x}_{i}}^{θ} ( z ) - {π}_{x , i , s}^{θ} ( z ) ) - 𝒦 ℒ ( {q}_{ϕ} ( z \vert x ) ‖ p ( z ) ) ] ; \qquad ( 13 )$$

c) compute gradient of the objective function;
d) optimize the outcome of the computed gradient;
e) repeat steps b), c), and d) until convergence;
f) decrease value of temperature parameter τ;
g) repeat steps b), c), d), e) and f) until temperature parameter τ is less than a predefined threshold; and
h) provide trained DD-VAE model.

In some embodiments, the computer-implemented method can include: sampling latent code from a prior distribution; supplying sampled latent code to a recurrent decoder of the DD-VAE; obtaining scores for all tokens prior to end of sequence token; selecting token with highest score; adding the selected token to end of a current generated sequence; supplying the sampled token as an input into the recurrent decoder; and generating an object with the recurrent decoder from the sampled token.

In some embodiments, the computer-implemented method can include: sampling latent code from a prior distribution; supplying sampled latent code to a decoder of the DD-VAE, wherein the decoder is configured as a convolutional decoder or a fully connected decoder; simultaneously obtaining scores for each possible value of each output element; selecting a possible value and highest score for each output element; supplying the selected output element as an input into the decoder; and generating an object with the decoder from the selected output element.

In some embodiments, a method of generating an object (e.g., real physical object, not a virtual object): performing a computer-implemented method to obtain a virtual object (e.g., generated object from deterministic decoder): providing a model configured as a deterministic decoder variational autoencoder; inputting object data into a stochastic encoder of the deterministic decoder variational autoencoder; generating latent codes in the latent space with the encoder; providing the latent codes from the latent space to a decoder, wherein the decoder is configured as a deterministic decoder; generating decoded objects with the decoder; and generating a report that identifies the decoded object. The method can then include physical steps that are not implemented on a computer, including: selecting a decoded object; and obtaining a physical form of the selected decoded object. In some aspects, the object is a molecule. In some aspects, the method includes validating the molecule to have at least one characteristic of the molecule. For example, the molecule physical characteristics or bioactivity can be tested.

In some embodiment, a computer system can include: one or more processors; and one or more non-transitory computer readable media storing instructions that in response to being executed by the one or more processors, cause the computer system to perform operations, the operations comprising the computer-implemented methods recited herein.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates the DD-VAE with a stochastic encoder of DD-VAE outputting parameters of bounded support distributions into the latent space that is then decoded with the deterministic decoder.

FIG. 2 shows that during sampling of the latent space, the recurrent neural network (RNN) decoder selects arg max of scores p_{θ}(xᵢ|x_{<i},z).

FIG. 3 shows the bounded support proposals for μ=0 and σ=1 which is derived with the [symbol] divergence.

FIG. 4 shows the [symbol] divergence for some bounded support kernels.

FIG. 5 shows the derived [symbol] divergences for a uniform prior.

FIG. 6 shows the function σ_{τ}(x) for different values of τ.

FIG. 7 shows an example computer system that can perform the computer-implemented methods recited herein.

FIG. 8A illustrates a method of training a DD-VAE (e.g., of FIG. 1).

FIG. 8B illustrates the deterministic decoder functionality, which can allow for improvement of the representation of learning capabilities of the DD-VAE, where the latent codes can be used for downstream tasks.

FIG. 8C illustrates an example where the DD-VAE can be used with a simplified molecular-input line-entry system (SMILES) to represent the molecules, which provides a system that represents a molecular graph as a string (e.g., sequence) using a depth-first search order traversal.

FIG. 8D shows a method to use bounded support proposal distributions how to avoid problems associated with the single data point produced for a given z.

FIG. 8E shows a method for optimizing a discontinuous function, for convergence of optimal parameters of an approximated ELBO to the optimal parameters of the original function.

FIG. 9A shows the DD-VAE with uniform prior and uniform proposal.

FIG. 9B shows the DD-VAE with uniform prior and tricube proposal.

FIG. 9C shows the VAE with the Gaussian prior and Gaussian proposal.

FIGS. 10A-10B show learned latent space structure for a baseline VAE with Gaussian prior and proposal and compare it to a DD-VAE with uniform prior and proposal.

FIG. 11 shows distribution learning with deterministic decoding on MOSES dataset.

FIG. 12 shows reconstruction accuracy (sequence-wise) and validity of samples on ZINC dataset; Predictive performance of sparse Gaussian processes on ZINC dataset: Log-likelihood (LL) and Root-mean-squared error (RMSE); Scores of top 3 molecules found with Bayesian Optimization.

FIG. 13 shows the top 3 molecules found with the different protocols.

FIG. 14 illustrates a method of training a DD-VAE.

FIG. 15 illustrates a method of generating an object with a DD-VAE that has a recurrent decoder.

FIG. 16 illustrates a method of generating an object with a DD-VAE that has a decoder configured as a convolutional decoder or a fully connected decoder.

The elements and components in the figures can be arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Deterministic Decoder VAE (DD-VAE)

A deterministic decoder variational autoencoder (DD-VAE) can be designed and formulated. Bounded support proposals can be used with the DD-VAE. A continuous relaxation of the DD-VAE's ELBO (evidence lower bond) can also be performed. It has been proven that the optimal solution of the relaxed problem matches the optimal solution of the original problem. Deterministic decoding simplifies the regression task leading to better predictive quality.

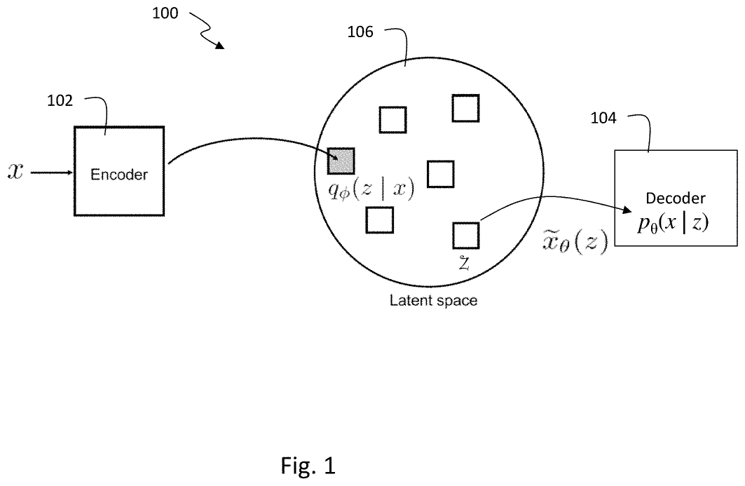

The variational autoencoders of the DD-VAE use a stochastic encoder and deterministic decoder. An encoder maps an object x onto a distribution of the latent codes q_{ϕ}(z|x), and a decoder produces a distribution p₀(x|z) of objects that correspond to a given latent code as shown in FIG. 1. FIG. 1 illustrates the DD-VAE 100 with a stochastic encoder 102 of DD-VAE outputting parameters of bounded support distributions into the latent space 106. With Gaussian proposals, lossless autoencoding is impossible, since the proposals of any two objects overlap. The DD-VAE can use a deterministic decoder 104 instead of stochastic decoding. Thus, in FIG. 1 the encoder 102 is a stochastic encoder and the decoder 104 is a deterministic decoder.

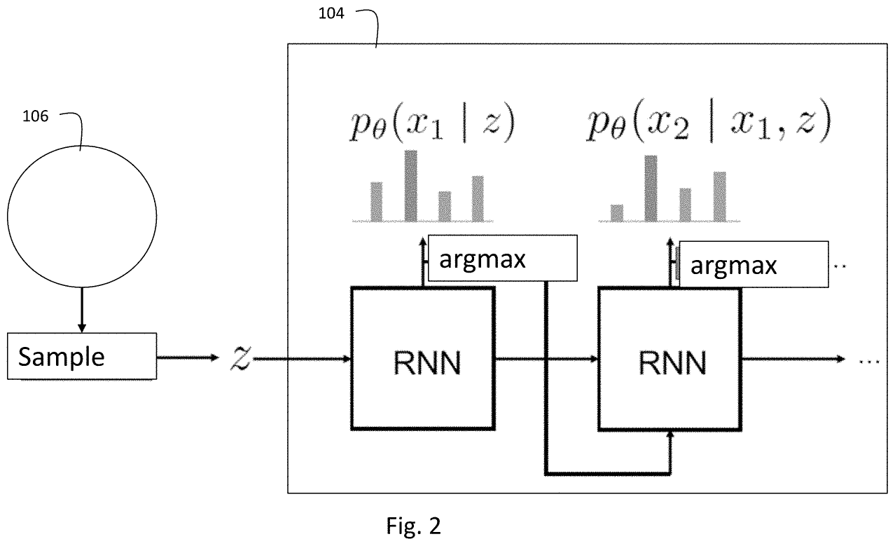

FIG. 2 shows that during sampling of the latent space 206, the recurrent neural network (RNN) decoder 104 selects argmax of scores p_{θ}(xᵢ|x_{<i},z). Hence, the only source of variation for the decoder is z. Therefore, a relaxed objective function can be used to optimize through argmax. With complex stochastic decoders, such as PixelRNN, VAEs tend to ignore the latent codes, since the decoder is flexible enough to produce the whole data distribution p(x) without using latent codes at all. Such behavior can damage the representation learning capabilities of VAE, and cannot use its latent codes for downstream tasks. A deterministic decoder for the DD-VAE maps each latent code to a single data point, making it harder to ignore the latent codes, as they are the only source of variation.

In the DD-VAE, the protocol conforms to the standard Gaussian prior, and studies the required properties of encoder and decoder to achieve deterministic decoding. The DD-VAE can be used with a simplified molecular-input line-entry system (SMILES) to represent the molecules, which provides a system that represents a molecular graph as a string using a depth-first search order traversal.

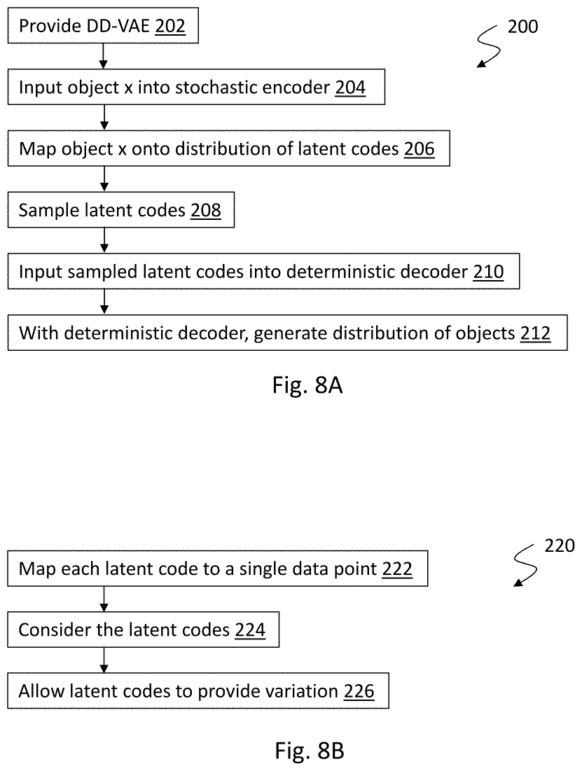

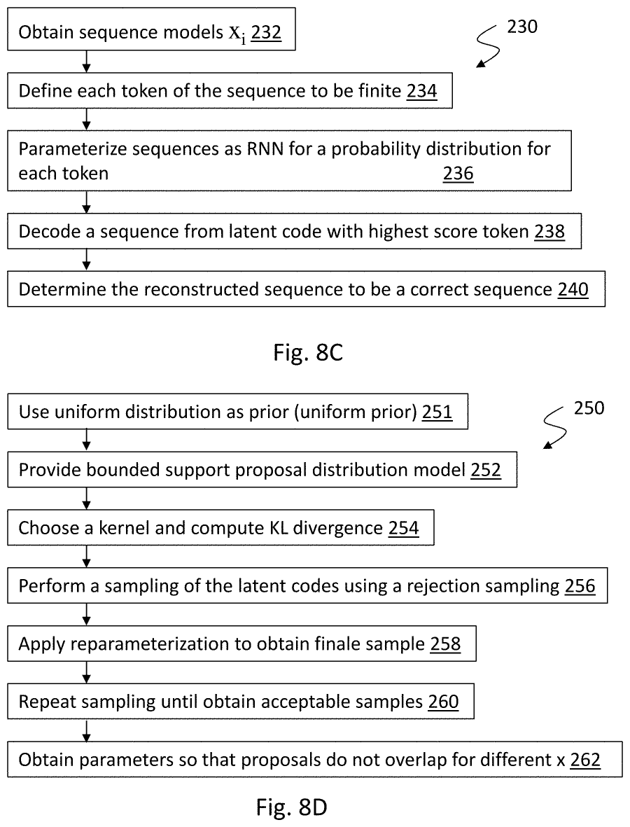

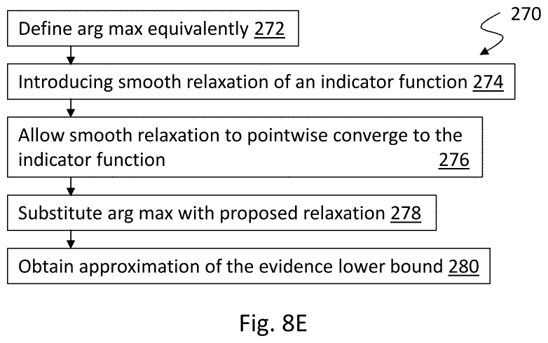

FIG. 8A illustrates a method 200 of training a DD-VAE (e.g., of FIG. 1). The method 200 can include providing the DD-VAE at block 202. The DD-VAE includes a stochastic encoder and deterministic decoder. The object x is input into a stochastic encoder at block 204. The encoder maps an object x onto a distribution of latent codes q_{ϕ}(z|x) at block 206. The latent codes are sampled at block 208. The sampled latent codes are input into the deterministic decoder at block 210. The deterministic decoder generates a distribution of objects p_{θ}(x|z) at block 212, the generated objects being generated based on the object x.

FIG. 8B illustrates the deterministic decoder functionality 220, which can allow for improvement of the representation of learning capabilities of the DD-VAE, where the latent codes can be used for downstream tasks. The deterministic decoder can map each latent code to a single data point at block 222. The latent codes are considered at bock 224 and the latent codes are allowed to provide the variation into the generated distribution of objects in block 226.

FIG. 8C illustrates an example where the DD-VAE can be used with a simplified molecular-input line-entry system (SMILES) to represent the molecules, which provides a system that represents a molecular graph as a string (e.g., sequence) using a depth-first search order traversal. The sequence models, xᵢ is a sequence x₁, x₂, . . . , x_{|x|}, is obtained at block 232. Each token of the sequence models is defined as an element of a finite vocabulary V at block 234. The sequences can have a decoding distribution parameterized as a recurrent neural network (RNN) that produces a probability distribution over each token xᵢ given the latent code and all previous tokens at block 236. The deterministic decoder decodes a sequence \tilde{x}₀(z) from a latent code z by taking a token with the highest score at each iteration at block 238. Then, the it is determined whether or not the reconstructed a correct sequence at block 240.

FIG. 8D shows a method 250 to use bounded support proposal distributions how to avoid problems associated with the single data point produced for a given z. A bounded support proposal distribution model is provided at block 252. The protocol can choose a kernel such that it can compute [symbol] divergence between q(z|x) and a prior p(z) analytically at block 254. Optionally, the densities of the [symbol] divergence can be determined and graphed. The latent code can be sampled using rejection sampling at block 256. Reparameterization is applied to obtain the final sample at block 258. The sampling is repeated until obtaining an acceptable sample at block 260. In some aspects, ith bounded support proposals, the protocol can use a uniform distribution U[−1, 1] as a prior (uniform prior) in VAE as long as the support of q_{ϕ}(z|x) lies inside the support of a prior distribution at block 251. Obtain set of parameters (θ, ϕ) for which proposals q_{ϕ}(z|x) do not overlap for different x, and hence ELBO [symbol] _{*}(θ, ϕ) is finite at block 262.

FIG. 8E shows a method 270 for optimizing a discontinuous function, for convergence of optimal parameters of an approximated ELBO to the optimal parameters of the original function. An arg max is equivalently defined at step 272. A smooth relaxation of an indicator function is introduced, parameterized with a temperature parameter, at block 274. The smooth relaxation is allowed to converge to the indicator function pointwise at block 276. The arg max is substituted with proposed relaxation at block 280 and an approximation of the evidence lower bound is obtained at block 280. This can be done for different temperature values τ.

In some embodiments, a method of generating objects with a DD-VAE can be performed as described herein. The method can include providing a model configured as a deterministic decoder variational autoencoder. Then, object data can be input into an encoder of the DD-VAE. Latent object data can be obtained with the encoder. The latent object data can be provided to a decoder, wherein the decoder is configured as a deterministic decoder. The decoder can generate decoded objects. The generated objects can be prepared into real life objects. The method can also include generating a report that identifies the decoded object, which can be stored in a memory device or provided for various uses. The report can be used for preparing the physical real life version of the object.

In some embodiments, the encoder outputs parameters of bounded support distribution. The Kullback-Leibler divergence can be computed that encourages latent codes to be marginally distributed as p(z). The decoder can select arg max of scores. A sequence can be decoded from a latent code by taking a token with a highest score. Mapping each latent code to a single data point can be performed with the deterministic decoder.

In some embodiments, the protocol can be performed using a bounded support proposal distribution. Also, the computing Kullback-Leibler divergence can be performed. In some aspects, a uniform distribution as a prior distribution for the encoder.

In some embodiments, the protocol can be performed by optimizing a discontinuous function by approximating it with a smooth function. In some aspects, defining an arg max can be performed. The arg max can be approximated with a smooth relaxation of an indicator function that is parameterized. Also, the arg max can be substituted with the smooth relaxation of the indicator function.

In some embodiments, object data is configured as sequential data. The sequential data can be chemical nomenclature that is in a sequence, such as SMILES.

In some embodiments, the method selects highest-scoring tokens instead of sampling. In some aspects, the decoder uses only latent codes for producing decoded objects. In some aspects, the latent codes are the only source of variation. In some aspects, the method uses bounded support proposal distributions.

In some aspects, the method includes using an objective function for training. In some aspects, the method can include deriving a Kulback-Leibler divergence against a Gaussian distribution and a uniform distribution. In some aspects, the method can include computing Kullback-Leibler divergence that encourages latent codes to be marginally distributed as p(z).

In some aspects, the method can include selecting a decoded object from a distribution of decoded objects or any object from the decoder. The decoded object represents a physical form when in computer data. The decoded object can then be used as a model for obtaining a physical form of the selected decoded object. In some aspects, the object is a molecule. That is, the selected decoded object can be prepared into a physical form, such as by synthesizing the chemical structure thereof. After preparation, the method can include validating the physical form of the selected decoded object. This can include testing the molecule in assays to determine whether or the molecule has an activity that is desired. The activity can be bioactivity in a biological pathway or some disease state.

In some embodiments, a computing system is provided for generating novel discrete objects using a machine learning model with the DD-VAE. The computing system can be programmed to have a stochastic encoder and a deterministic decoder. The computing system can be programmed for performing a training method that is derived from the training method of variational autoencoders. The computing system can be configured for performing a smooth approximation of an objective function. In some aspects, the stochastic encoder can be configured for an encoded distribution that has bounded support. Example bounded support distributions can be used where distribution is parameterized by a shifted and scaled bounded support kernel. The computing system can be configured for obtaining derived Kulback-Leibler divergences for bounded support distribution for a standard Gaussian distribution and uniform distribution.

The computing system can be programmed for learning Variational Autoencoders with deterministic decoders, and where the decoder maps latent codes to a single object. The computing system has two novel components: bounded support proposal distributions and a novel objective function for training. For novel bounded support proposal distributions, the protocol derives Kulback-Leibler divergence against a Gaussian distribution and a uniform distribution. The proposed objective function can achieve lossless compression.

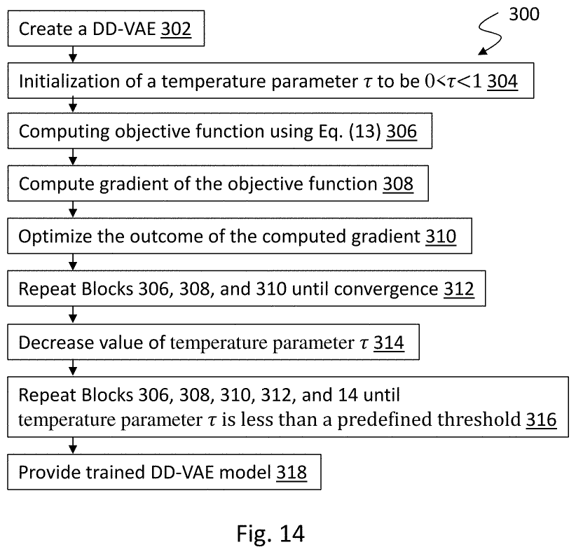

FIG. 14 illustrates a method 300 of training a DD-VAE. The method can include creating a DD-VAE at block 302, such as by computer programming. The DD-VAE can include an encoder network and a decoder network. The encoder can be a stochastic encoder. The decoder is not a stochastic decoder. Instead, the decoder is a deterministic decoder. The DD-VAE can include the networks thereof to be recurrent neural networks, fully connected neural network, or a convolution network. The training method 300 can include an initialization of a temperature parameter τ with a positive value that is less than one, such that 0<τ<1, at block 304. The method 300 can include computing an objection function using Eq. (13) (provided herein) at block 306. A gradient of the objective function is computed with Eq. (13) with respect to encoder and decoder parameters at block 308. Optimization is performed with the result of the computed gradient using an optimizer function at block 310. The optimizer function can be any of Stochastic gradient descent (SGD), Adam, AdaDelta, Bayesian optimizer, or others. The steps of blocks 306, 308, and 310 can be repeated until convergence at block 312. The value of the temperature parameter τ is then decreased according to a decreasing schedule at block 314, which decrease schedule can be by multiplying temperature parameter τ by a constant value (cv) from zero to 1 (0<cv<1), subtracting a fixed value from the temperature parameter τ, or other. The steps of blocks 306, 308, 310, 312, and 314 can be repeated until temperature parameter τ is less than a predefined threshold at block 316. Then, the trained DD-VAE model can be provided at block 318.

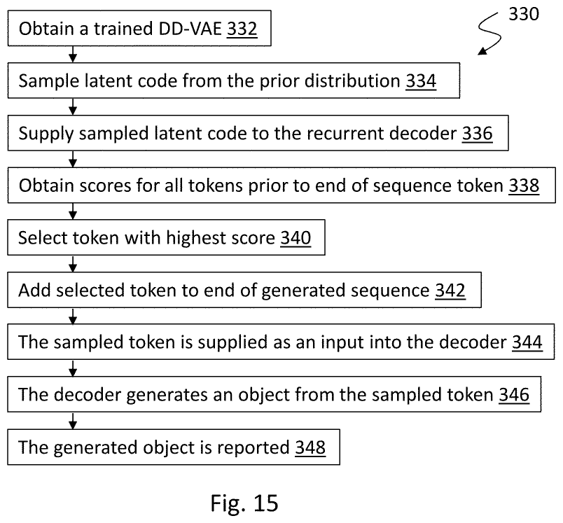

FIG. 15 illustrates a method 330 of generating objects using a DD-VAE, such as the one trained according to FIG. 14, with a recurrent decoder. The method 330 can include obtaining a trained DD-VAE at block 332. The latent space having latent codes can be sampled from a prior distribution at block 334. The sampled latent code is then supplied to the recurrent decoder at block 336. Obtain scores for all tokens while “end of sequence token” has not been generated at block 338. Select the token with the highest score at block 340. Add the selected token to the end of the current generated sequence at block 342. Then, the sampled token is supplied as an input into the decoder on the following iteration at block 344. The sampled token is generated into an object by the decoder at block 346. Then, the generated object is provided, such as in a report, at block 348. The generated object is a virtual object that can be used as a blueprint for preparing a physical version of the generated object.

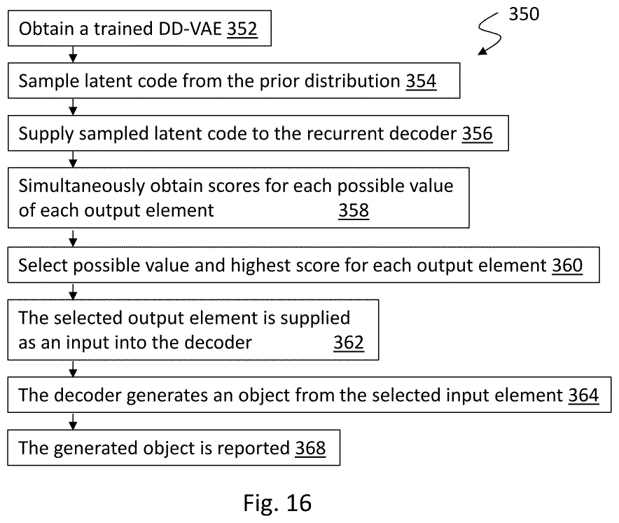

FIG. 16 illustrates a method 350 of generating objects using a DD-VAE, such as the one trained according to FIG. 14, with a convolutional decoder or fully connected decoder. The method 350 can include obtaining a trained DD-VAE at block 352. The latent space having latent codes can be sampled from a prior distribution at block 354. The sampled latent code is then supplied to the convolutional decoder or fully connected decoder at block 356. Then, all of the scores for each possible value of each output element is simultaneously obtained at block 358. For each output element, select the possible value with the highest score at block 360. Then, the selected output element is supplied as an input into the decoder on the following iteration at block 362. The selected output element is generated into an object by the decoder at block 364. Then, the generated object is provided, such as in a report, at block 366. The generated object is a virtual object that can be used as a blueprint for preparing a physical version of the generated object.

In some embodiments, instead of a variational autoencoder, a base algorithm can optimize the adversarial autoencoder's objective function.

In some embodiments, the model encoder and decoder can take any form of a neural network, including recurrent networks, convolutional networks, attention networks, and others.

The object data can be sequence data, which indicates the object can be represented by a sequence. The sequence can be a line of tokens or identifiers that when put together provide an indication or sequence representation of the object. During the processing described herein the machine learning systems run iterations, which iterations can be used to process the data to learn the data as well as reconstruct new objects from the learned data. The iterations can also be run with the sequences, where the sequence can be considered to be tokens or identifiers, where each iteration can process all of the tokens or identifiers, or each token or identifier in the sequence can be processed in the sequence. Chemical structures in the SMILES format are good examples of such sequences.

### Examples

### Synthetic Data

The DD-VAE is tested by performing an experiment on four datasets: synthetic and MNIST datasets to visualize a learned manifold structure; on MOSES molecular dataset to analyze the distribution quality of DD-VAE; and ZINC dataset to see if DD-VAE latent codes are suitable for goal-directed optimization.

The dataset provides a proof of concept comparison of standard VAE with a stochastic decoder and a DD-VAE model with a deterministic decoder. The data consist of 6-bit strings, a probability of each string is given by independent Bernoulli samples with a probability of 1 being 0.8. For example, a probability of string “110101” is 0.8⁴. 0.2²≈0.016.

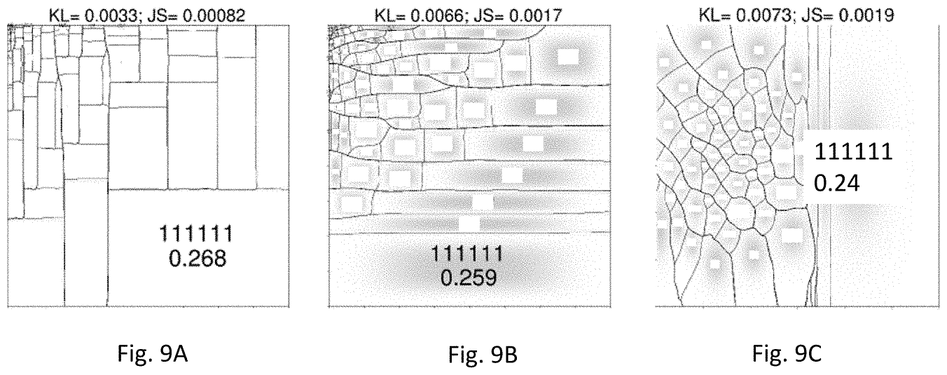

In FIGS. 9A-9C, the 2D latent codes learned with the proposed model are illustrated. As an encoder and decoder, a 2-layer gated recurrent unit (GRU) network is used with a hidden size 128. The model is provided with a uniform prior and compare uniform and tricube proposals. For a baseline model, a β-VAE with Gaussian proposal and prior was trained. We used β=0.1, as for larger β we observed posterior collapse. For our model, we used β=1, which is equivalent to the described model. FIG. 9A shows the DD-VAE with uniform prior and uniform proposal. FIG. 9B shows the DD-VAE with uniform prior and tricube proposal. FIG. 9C shows the VAE with the Gaussian prior and Gaussian proposal. The 2D manifold is learned on synthetic data. Dashed lines indicate proposal boundaries, solid lines indicate decoding boundaries. For each decoded string, we write its probability under deterministic decoding.

For a baseline model, an irregular decision boundary is observed, which also behaves unpredictably for latent codes that are far from the origin. Both uniform and tricube proposals learn a brick-like structure that covers the whole latent space. During training, it is observed that the uniform proposal tends to separate proposal distributions by a small margin to ensure there is no overlap between them. As the training continues, the width of proposals grows until they cover the whole latent space. For the tricube proposal, we observed a similar behavior, although the model tolerates slight overlaps.

Encoder and decoder were GRUs with 2 layers of 128 neurons. The latent size was 2; embedding dimension was 8. We trained the model for 100 epochs with Adam optimizer with an initial learning rate 5 10⁻³, which halved every 20 epochs. The batch size was 512. We fine-tuned the model for 10 epochs after training by fixing the encoder and learning only the decoder. For a proposed model with a uniform prior and a uniform proposal, we increased [symbol] weight β linearly from 0 to 0.1 during 100 epochs. For the Gaussian and tricube proposals, we increased [symbol] weight β linearly from 0 to 1 during 100 epochs. For all three experiments, we pretrained the autoencoder for the first two epochs with β=0. We annealed the temperature from 10⁻¹ to 10⁻³ during 100 epochs of training in a log-linear scale. For a tricube proposal, we annealed the temperature to 10⁻².

Binary MNIST

To evaluate the model on imaging data, we considered a binarized dataset obtained by thresholding the original 0 to 1 gray-scale images by a threshold of 0.3. The goal of this experiment is to visualize how DD-VAE learns 2D latent codes on moderate size datasets.

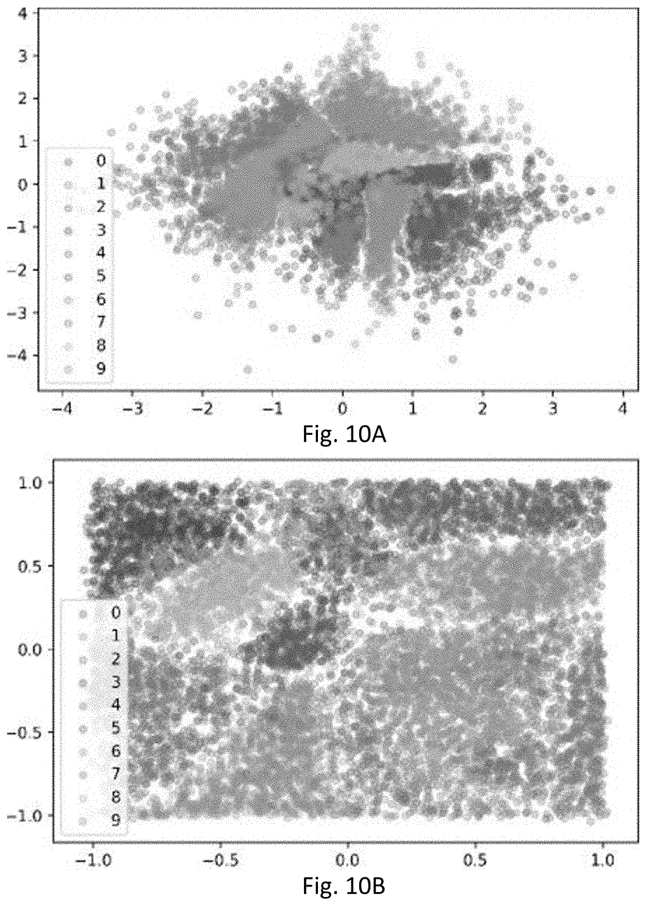

For this experiment, we trained a 4-layer fully-connected encoder and decoder with structure 784 to 256 to 128 to 32 to 2. In FIGS. 10A-10B, we show learned latent space structure for a baseline VAE with Gaussian prior and proposal and compare it to a DD-VAE with uniform prior and proposal. Note that the uniform representation evenly covers the latent space, as all points have the same prior probability. This property is useful for visualization tasks. The learned structure better separates classes, although it was trained in an unsupervised manner: K-nearest neighbor classifier on 2D latent codes yields 87.8% accuracy for DD-VAE and 86.1% accuracy for VAE.

We binarized the dataset by thresholding original MNIST pixels with a value of 0.3. We used a fully connected neural network with layer sizes 784 to 256 to 128 to 32 to 2 with LeakyReLU activation functions. We trained the model for 150 epochs with a starting learning rate 5×10⁻³ that halved every 20 epochs. We used a batch size 512 and clipped the gradient with value 10. We increased 3 from 10⁻⁵ to 0.005 for VAE and 0.05 for DD-VAE. We decreased the temperature in a log scale from 0.01 to 0.0001

Molecular Sets (MOSES)

We compare the models on a distribution learning task on MOSES dataset. MOSES dataset contains approximately 2 million molecular structures represented as SMILES strings; MOSES also implements multiple metrics, including Similarity to Nearest Neighbor (SNN/Test) and Frechet ChemNet Distance (FCD/Test). SNN/Test is an average Tanimoto similarity of generated molecules to the closest molecule from the test set. Hence, SNN acts as precision and is high if generated molecules lie on the test set's manifold. FCD/Test computes Frechet distance between activations of a penultimate layer of ChemNet for generated and test sets. Lower FCD/Test indicates a closer match of generated and test distributions.

We monitor the model's behavior for high reconstruction accuracy. We trained a 2-layer GRU encoder and decoder with 512 neurons and a latent dimension 64 for both VAE and DD-VAE. We pretrained the models with such 3 that the sequence wise reconstruction accuracy was approximately 95%. We monitored FCD/Test and SNN/Test metrics while gradually increasing 3 until sequence-wise reconstruction accuracy dropped below 70%.

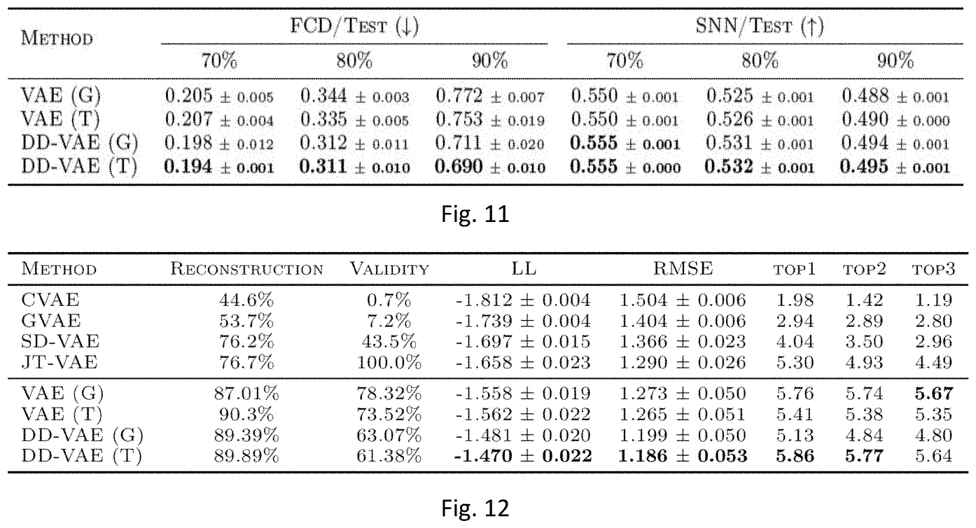

In the results reported in FIG. 11, DD-VAE outperforms VAE on both metrics. Bounded support proposals have less impact on the target metrics, although they slightly improve both FCD/Test and SNN/Test. FIG. 11 shows distribution learning with deterministic decoding on MOSES dataset. We report generative modeling metrics: FCD/Test (lower is better) and SNN/Test (higher is better). Mean±std over multiple runs. G=Gaussian proposal, T=Triweight proposal.

We used a 2-layer GRU network with a hidden size of 512. Embedding size was 64, the latent space was 64-dimensional. We used a tricube proposal and a Gaussian prior. We pretrained a model with a fixed 3 for 20 epochs and then linearly increased 3 for 180 epochs. We halved the learning rate after pretraining. For DD-VAE models, we decreased the temperature in a log scale from 0.2 to 0.1. We linearly increased 3 divergence from 0.0005 to 0.01 for VAE models and from 0.0015 to 0.02.

Bayesian Optimization

A standard use case for generative molecular autoencoders for molecules is Bayesian Optimization (BO) of molecular properties on latent codes. For this experiment, we trained a 1-layer GRU encoder and decoder with 1024 neurons on ZINC with latent dimension 64. We tuned hyperparameters such that the sequence-wise reconstruction accuracy on train set was close to 96% for all our models. The models showed good reconstruction accuracy on test set and good validity of the samples (FIG. 12). We explored the latent space using a standard two-step validation procedure proposed in to show the advantage of DD-VAE's latent codes. The goal of the Bayesian optimization was to maximize the following score of a molecule m:

score(m)=Log P(m)−SA(m)−cycle(m) (25)

where log P(m) is water-octanol partition coefficient of a molecule, SA(m) is a synthetic accessibility score obtained from RDKit package, and cycle(m) penalizes the largest ring Rₘₐₓ (m) in a molecule if it consists of more than 6 atoms:

cycle(m)=max(0,|−6) (26)

Each component in score(m) is normalized by subtracting mean and dividing by standard deviation estimated on the training set. Validation procedure consists of two steps. First, we train a sparse Gaussian process on latent codes of DD-VAE trained on approximately 250,000 SMILES stings from ZINC database, and report predictive performance of a Gaussian process on a ten-fold cross validation in FIG. 12. We compare DD-VAE to the following baselines: Character VAE, CVAE; Grammar VAE, GVAE; Syntax-Directed VAE, SD-VAE; Junction Tree VAE, JT-VAE. FIG. 12 shows reconstruction accuracy (sequence-wise) and validity of samples on ZINC dataset; Predictive performance of sparse Gaussian processes on ZINC dataset: Log-likelihood (LL) and Root-mean-squared error (RMSE); Scores of top 3 molecules found with Bayesian Optimization. G=Gaussian proposal, T=Tricube proposal.

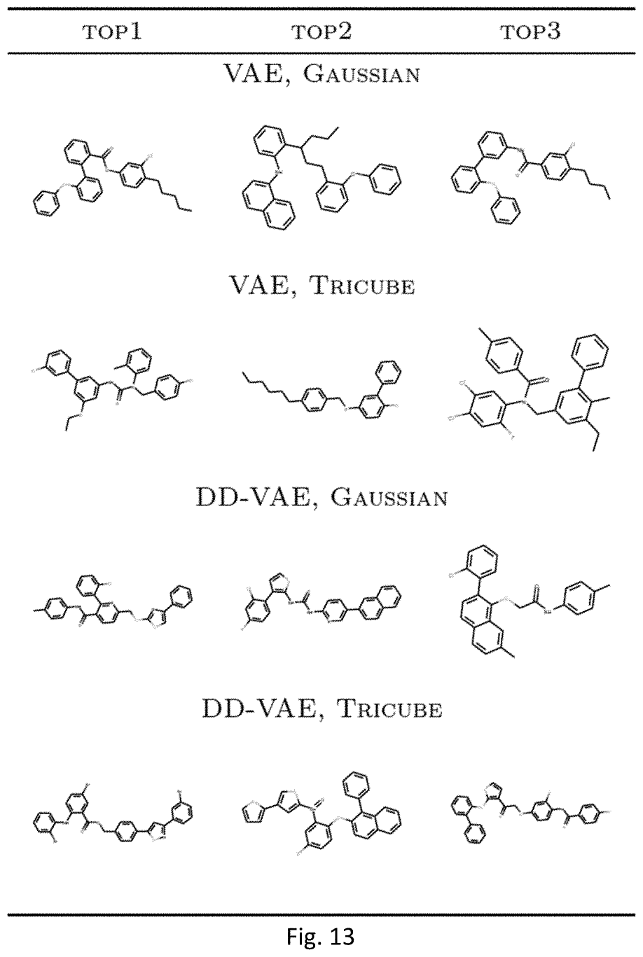

Using a trained sparse Gaussian process, we iteratively sampled 60 latent codes using expected improvement acquisition function and Kriging Believer Algorithm to select multiple points for the batch. We evaluated selected points and added reconstructed objects to the training set. We repeated training and sampling for 5 iterations and reported molecules with the highest score in FIG. 12 and FIG. 13.

The proposed model outperforms the standard VAE model on multiple downstream tasks, including Bayesian optimization of molecular structures. In the ablation studies, we noticed that models with bounded support show lower validity during sampling. We suggest that it is due to regions of the latent space that are not covered by any proposals: the decoder does not visit these areas during training and can behave unexpectedly there. We found a uniform prior suitable for downstream classification and visualization tasks since latent codes evenly cover the latent space.

DD-VAE introduces an additional hyperparameter τ that balances reconstruction and [symbol] terms. Unlike [symbol] scale β, temperature τ changes loss function and its gradients non-linearly. We found it useful to select starting temperatures such that gradients from [symbol] and reconstruction term have the same scale at the beginning of training. Experimenting with annealing schedules, we found log-linear annealing slightly better than linear annealing.

We used a 1-layer GRU network with a hidden size of 1024. Embedding size was 64, the latent space was 64-dimensional. We used a tricube proposal and a Gaussian prior. We trained a model for 200 epochs with a starting learning rate 5×10⁻⁴ that halved every 50 epochs. We increased divergence weight 3 from 10⁻³ to 0.02 linearly during the first 50 epochs for DD-VAE models, from 10⁻⁴ to 5·×10⁻⁴ for VAE model, and from 10⁻⁴ to 8·×10⁻⁴ for VAE model with a tricube proposal. We decreased the temperature log-linearly from 10⁻³ to 10⁻⁴ during the first 100 epochs for DD-VAE models. With such parameters we achieved a comparable train sequence-wise reconstruction accuracy of 95%.

Machine Learning Protocol

Variational autoencoder (VAE) includes an encoder q_{ϕ}(z|x) and a decoder p_{θ}(x|z). The model learns a mapping of data distribution p(x) onto a prior distribution of latent codes p(z), which is often a standard Gaussian N (0, I). Parameters θ and ϕ are learned by maximizing a lower bound L(θ, ϕ) on a log marginal likelihood log p(x). L(θ, ϕ) is known as an evidence lower bound (ELBO):

$$ℒ ( θ , ϕ ) = {𝔼}_{x ∼ p ( x )} [ {𝔼}_{z ∼ {q}_{ϕ}} ( z \vert x ) log {p}_{θ} ( x \vert z ) - 𝒦 ℒ ( {q}_{ϕ} ( z \vert x ) ‖ p ( z ) ) ] \qquad ( 1 )$$

The log p₀(x|z) term in Eq. 1 is a reconstruction loss, and the KL term is a Kullback-Leibler divergence that encourages latent codes to be marginally distributed as p(z).

For sequence models, xᵢ is a sequence x₁, x₂, . . . , x_{|x|}, where each token of the sequence is an element of a finite vocabulary V, and |x| is the length of sequence x. A decoding distribution for sequences is often parameterized as a recurrent neural network that produces a probability distribution over each token xᵢ given the latent code and all previous tokens. The ELBO for such model is:

$$ℒ ( θ , ϕ ) = {𝔼}_{x ∼ p ( x )} [ {𝔼}_{z ∼ {q}_{ϕ} ( z \vert x )} log {p}_{θ} ( x \vert z ) - 𝒦ℒ ( {q}_{ϕ} ( z \vert x ) \vert \vert p ( z ) ) ] \qquad ( 2 )$$

where π_{x,i,s}^{θ}(z)=p_{θ}(xᵢ=s|z, x₁, x₂, . . . , xᵢ₋₁).

In deterministic decoders, the protocol decodes a sequence \tilde{x}_{θ}(z) from a latent code z by taking a token with the highest score at each iteration:

$${\tilde{x}}_{i} = {arg max}_{s ∈ V} {p}_{θ} ( s \vert z , {x}_{1} , … , {x}_{i - 1} ) = {arg max}_{s ∈ V} {π}_{x , i , s}^{θ} ( z ) \qquad ( 3 )$$

To avoid ambiguity, when two tokens have the same maximal probability, arg max is equal to a special “undefined” token that does not appear in the data. Such formulation simplifies derivations. The protocol can also assume π_{x,i,s}^{θ}∈[0, 1] for convenience. After decoding \tilde{x}_{θ}, the reconstruction term of ELBO is an indicator function which is one, if the model reconstructed a correct sequence, and zero otherwise:

$$\begin{matrix} p ( x \vert {\tilde{x}}_{θ} ( z ) ) = \{ \begin{matrix}1 , {\tilde{x}}_{θ} ( z ) = x \\ 1 , otherwise\end{matrix} & ( 4 ) \\ {ℒ}_{*} ( θ , ϕ ) = {𝔼}_{x ∼ p ( x )} [ {𝔼}_{z ∼ {q}_{ϕ} ( z \vert x )} log p ( x \vert {\tilde{x}}_{θ} ( z ) ) - 𝒦ℒ ( {q}_{ϕ} ( z \vert x ) \vert \vert p ( z ) ) ] . & ( 5 )\end{matrix}$$

The [symbol] _{*}(θ, ϕ) is −∞ if the model has non-zero reconstruction error rate.

Now, the bounded support proposal distributions q_{ϕ}(z|x) in VAEs and why they are useful for deterministic decoders is described. Variational Autoencoders often use Gaussian proposal distributions:

q_{ϕ}(z|x)= [symbol] (z|μ_{ϕ}(x),Σ_{ϕ}(x)) (6)

where μ_{ϕ}(x) and Σ_{ϕ}(x) are neural networks modeling the mean and the covariance matrix of the proposal distribution. For a fixed z, Gaussian density q_{ϕ}(z|x) is positive for any x. Hence, a lossless decoder has to decode every x from every z with a positive probability. However, a deterministic decoder can produce only a single data point \tilde{x}_{θ}(z) for a given z, making reconstruction term of [symbol] , minus infinity. To avoid this problem, the protocols use bounded support proposal distributions.

As bounded support proposal distributions, we suggest to use factorized distributions with marginals defined using a kernel K:

$${q}_{ϕ} ( z \vert x ) = {\prod }_{i = 1}^{d} \frac{1}{{σ}_{i}^{ϕ} ( x )} K ( \frac{{z}_{i} - {μ}_{i}^{ϕ} ( x )}{{σ}_{i}^{ϕ} ( x )} ) \qquad ( 7 )$$

where μᵢ^{ϕ}(x) and σᵢ^{ϕ}(x) are neural networks that model location and bandwidth of a kernel K; the support of i-th dimension of z in q_{ϕ}(z|x) is a range:

[μᵢ^{ϕ}(x),μᵢ^{ϕ}(x)+σᵢ^{ϕ}(x)]

The protocol can choose a kernel such that it can compute [symbol] divergence between q(z|x) and a prior p(z) analytically. If p(z) is factorized, [symbol] divergence is a sum of one-dimensional [symbol] divergences:

$$𝒦ℒ ( {q}_{ϕ} ( z \vert x ) \vert \vert p ( z ) ) = {\sum }_{i = 1}^{d} 𝒦ℒ ( {q}_{ϕ} ( {z}_{i} \vert x ) \vert \vert p ( {z}_{i} ) ) \qquad ( 8 )$$

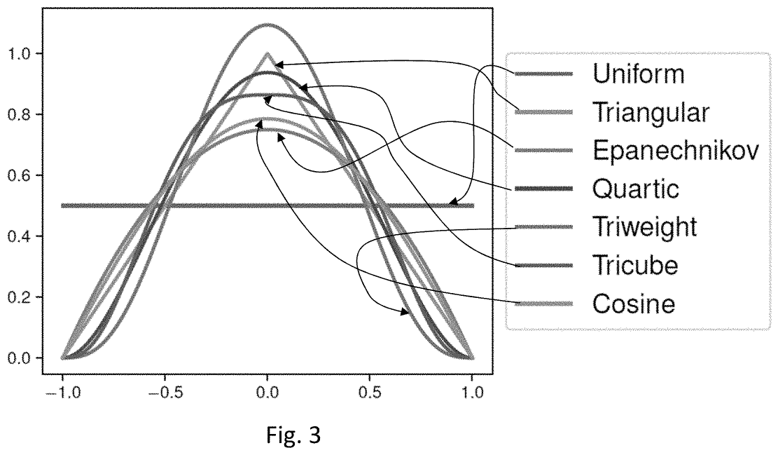

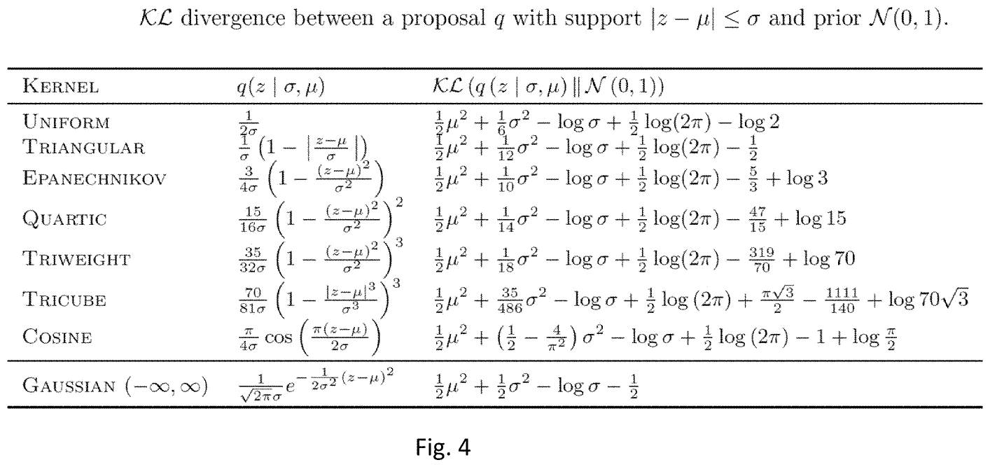

In FIG. 4, [symbol] divergence is shown for some bounded support kernels and their densities are illustrated in FIG. 3. Note that the form of [symbol] divergence is very similar to the one for a Gaussian proposal distribution, where they only differ in a constant multiplier for σ² and an additive constant. For sampling, we use rejection sampling from K(ϵ) with a uniform proposal K(0)· [symbol] [−1,1] and apply a reparametrization to obtain a final sample: z=ϵ·σ+μ. The acceptance rate in such sampling is 1/(2K(0)). Hence, to sample a batch of size N, the protocol samples N·2K(0) objects and repeat sampling until obtain at least N accepted samples. The protocol also stores a buffer with excess samples and uses them in the following batches.

FIG. 3 shows the bounded support proposals for μ=0 and σ=1 which is derived with the [symbol] divergence.

With bounded support proposals, the protocol can use a uniform distribution U[−1, 1]^{d} as a prior in VAE as long as the support of q_{ϕ}(z|x) lies inside the support of a prior distribution. In practice, the protocol ensures this by transforming μ and σ from the encoder into μ′ and σ′ using the following transformation:

$$\begin{matrix}{μ}^{′} = \frac{tanh ( μ + σ ) + tanh ( μ - σ )}{2} & ( 9 ) \\ {σ}^{′} = \frac{tanh ( μ + σ ) - tanh ( μ - σ )}{2} & ( 10 )\end{matrix}$$

The derived [symbol] divergences for a uniform prior are reported in FIG. 5.

For discrete data, with bounded support proposals the protocol can ensure that for sufficiently flexible encoder and decoder, there exists a set of parameters (θ, ϕ) for which proposals q_{ϕ}(z|x) do not overlap for different x, and hence ELBO [symbol] _{*}(θ,ϕ) is finite. For example, the protocol can enumerate all objects and map i-th object to a range [i, i+1].

Optimization of a discontinuous function [symbol] _{*}(θ,ϕ) can be performed by approximating it with a smooth function. The protocol also shows the convergence of optimal parameters of an approximated ELBO to the optimal parameters of the original function.

The protocol equivalently defines arg max from Eq. 3 for some array r:

$$𝕀 [ i = {arg max}_{j} {r}_{j} ] = {Π}_{j \neq i} 𝕀 [ {r}_{i} > {r}_{j} ] \qquad ( 11 )$$

Eq. 11 is approximated by introducing a smooth relaxation σ_{τ}(x) of an indicator function [symbol] [x>0] parameterized with a temperature parameter τ∈(0,1):

$$𝕀 [ x > 0 ] \approx {σ}_{τ} ( x ) = \frac{1}{1 + exp ( - x \text{/} τ ) [ \frac{1}{τ} - 1 ]} \qquad ( 12 )$$

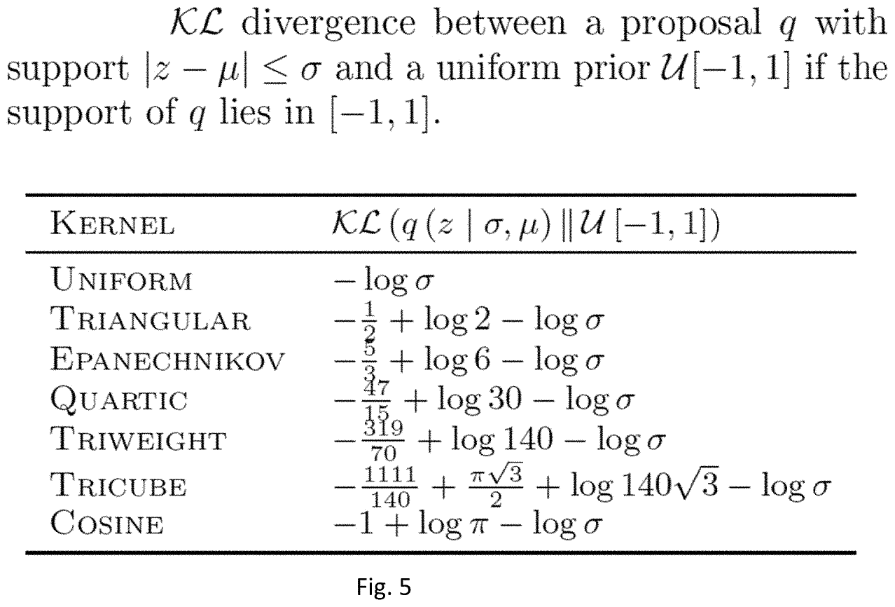

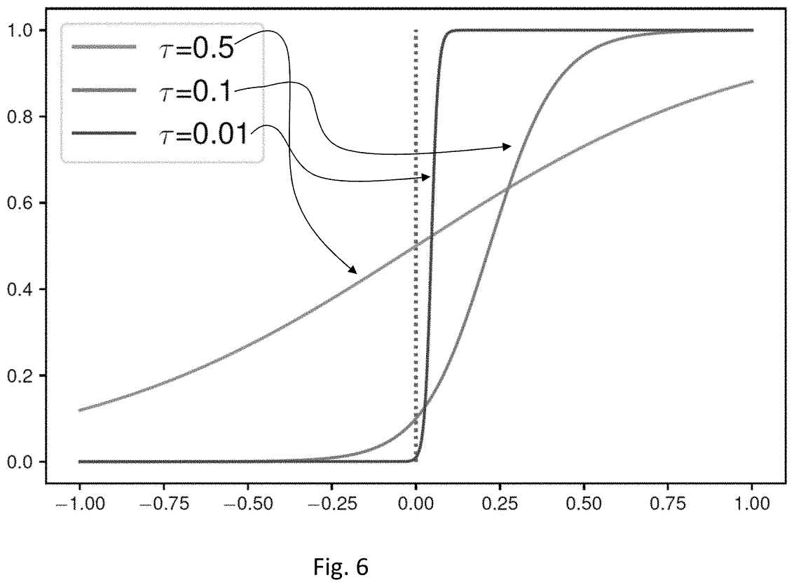

Note that σ_{τ}(x) converges to [symbol] [x>0] pointwise. In FIG. 6, the function σ_{τ}(x) for different values of τ is shown. Substituting arg max with the proposed relaxation, the protocol obtains the following approximation of the evidence lower bound:

$${ℒ}_{τ} ( θ , ϕ ) = {𝔼}_{x ∼ p ( x )} [ {𝔼}_{z ∼ {q}_{ϕ} ( z \vert x )} {\sum }_{i = 1}^{\vert x \vert} {\sum }_{s \neq {x}_{i}} log {σ}_{τ} ( {π}_{x , i , {x}_{i}}^{θ} ( z ) - {π}_{x , i , s}^{θ} ( z ) ) - 𝒦ℒ ( {q}_{ϕ} ( z \vert x ) \vert \vert p ( z ) ) ] \qquad ( 13 )$$

FIG. 6 shows the relaxation of σ_{τ}(x) of an indicator function [symbol] [x>0] for different τ.

A proposed [symbol] _{τ} is finite for 0<τ<1 and converges to [symbol] _{*} pointwise. If there is a gradually decrease in temperature τ and solve maximization problem for ELBO [symbol] _{τ}, it will converge to optimal parameters of a non-relaxed ELBO [symbol] _{*}.

Convergence of optimal parameters of [symbol] _{τ} can be used to get optimal parameters of [symbol] _{*}. The protocol can introduce auxiliary functions that are useful for assessing the quality of the model and formulate a theorem on the convergence of optimal parameters of [symbol] _{τ} to optimal parameters of [symbol] _{*}. Denote Δ(\tilde{x}_{θ},ϕ) a sequence-wise error rate for a given encoder and decoder:

Δ(\tilde{x}_{θ},ϕ)= [symbol] _{x˜p(x)} [symbol] _{z˜q}_{_{ϕ}}_{(z|x)} [symbol] [\tilde{x}_{θ}(z)≠x] (14)

For a given ϕ, find an optimal decoder and a corresponding sequence-wise error rate Δ(ϕ) by rearranging the terms in Eq. 14 and applying importance sampling:

$$\begin{matrix}Δ ( {\tilde{x}}_{θ} , ϕ ) = 1 - {𝔼}_{z ∼ p ( z )} {𝔼}_{x ∼ p ( x )} \frac{{q}_{ϕ} ( z \vert x )}{p ( z )} 𝕀 [ {\tilde{x}}_{θ} ( z ) = x ] \\ = 1 - {𝔼}_{z ∼ p ( z )} \frac{p ( {\tilde{x}}_{θ} ( z ) ) {q}_{ϕ} ( z \vert {\tilde{x}}_{θ} ( z ) )}{p ( z )} \\ \geq 1 - {𝔼}_{z ∼ p ( z )} \frac{p ( {\tilde{x}}_{ϕ}^{*} ( z ) ) {q}_{ϕ} ( z \vert {\tilde{x}}_{ϕ}^{*} ( z ) )}{p ( z )} \\ = Δ ( {\tilde{x}}_{ϕ}^{*} , ϕ ) = Δ ( ϕ ) \geq 0 ,\end{matrix} \qquad ( 15 )$$

when \tilde{x}_{ϕ}*(z) is an optimal decoder given by:

$${\tilde{x}}_{ϕ}^{*} ( z ) ∈ {Arg max}_{x ∈ χ} p ( x ) {q}_{ϕ} ( z \vert x ) \qquad ( 16 )$$

The χ is a set of all possible sequences. Denote Ω a set of parameters of which ELBO [symbol] _{*} is finite

Ω={(θ,ϕ)| [symbol] _{*}(θ,ϕ)>−∞} (17).

The maximum length of sequences is bounded in the majority of practical applications. Equicontinuity assumption is satisfied for all distributions considered in Table 1 if μ and σ depend continuously on ϕ for all x∈χ.

The Ω is not empty for bounded support distributions when encoder and decoder are sufficiently flexible, as discussed herein.

The data suggests that after finishing training the autoencoder, the protocol can fix the encoder and fine-tune the decoder. Since Δ(ϕ)=0, the optimal stochastic decoder for such ϕ is deterministic, and any z corresponds to a single x except for a zero probability subset. It is thought that learning \tilde{θ} for a fixed \tilde{ϕ} by optimizing a reconstruction of the term of ELBO from Eq 2:

$${ℒ}_{rec} ( θ ) = {𝔼}_{x ∼ p ( x )} {𝔼}_{x ∼ {q}_{\tilde{ϕ}} ( z \vert x )} {\sum }_{i = 1}^{\vert x \vert} log {π}_{x , i , {x}_{i}}^{θ} , \qquad ( 24 )$$

However, in practice the protocol does not anneal the temperature exactly to zero, thereby fine-tuning is optional.

Autoencoder-based generative models have an encoder-decoder pair and a regularizer that forces encoder outputs to be marginally distributed as a prior distribution. This regularizer can take a form of a [symbol] divergence as in Variational Autoencoders or an adversarial loss as in Adversarial Autoencoders and Wasserstein Autoencoders. Besides autoencoder-based generative models, generative adversarial networks (and normalizing flows were shown to be useful for sequence generation.

Variational autoencoders are prone to posterior collapse when the encoder outputs a prior distribution, and a decoder learns the whole distribution ρ(x) by itself. Posterior collapse often occurs for VAEs with autoregressive decoders such as PixelRNN. Multiple approaches can alleviate posterior collapse, including decreasing the weight β of a divergence, or encouraging high mutual information between latent codes and corresponding objects.

In the present technology, the protocol conforms to the standard Gaussian prior, and studies the required properties of encoder and decoder to achieve deterministic decoding.

The present technology can be used with a simplified molecular-input line-entry system (SMILES) to represent the molecules, which provides a system that represents a molecular graph as a string using a depth-first search order traversal.

One skilled in the art will appreciate that, for the processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In one embodiment, the present methods can include aspects performed on a computing system. As such, the computing system can include a memory device that has the computer-executable instructions for performing the methods. The computer-executable instructions can be part of a computer program product that includes one or more algorithms for performing any of the methods of any of the claims.

In one embodiment, any of the operations, processes, or methods, described herein can be performed or cause to be performed in response to execution of computer-readable instructions stored on a computer-readable medium and executable by one or more processors. The computer-readable instructions can be executed by a processor of a wide range of computing systems from desktop computing systems, portable computing systems, tablet computing systems, hand-held computing systems, as well as network elements, and/or any other computing device. The computer readable medium is not transitory. The computer readable medium is a physical medium having the computer-readable instructions stored therein so as to be physically readable from the physical medium by the computer/processor.

There are various vehicles by which processes and/or systems and/or other technologies described herein can be effected (e.g., hardware, software, and/or firmware), and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The various operations described herein can be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware are possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a physical signal bearing medium include, but are not limited to, the following: a recordable type medium such as a floppy disk, a hard disk drive (HDD), a compact disc (CD), a digital versatile disc (DVD), a digital tape, a computer memory, or any other physical medium that is not transitory or a transmission. Examples of physical media having computer-readable instructions omit transitory or transmission type media such as a digital and/or an analog communication medium (e.g., a fiber optic cable, a waveguide, a wired communication link, a wireless communication link, etc.).

It is common to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. A typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems, including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. Such depicted architectures are merely exemplary, and that in fact, many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include, but are not limited to: physically mateable and/or physically interacting components and/or wirelessly interactable and/or wirelessly interacting components and/or logically interacting and/or logically interactable components.

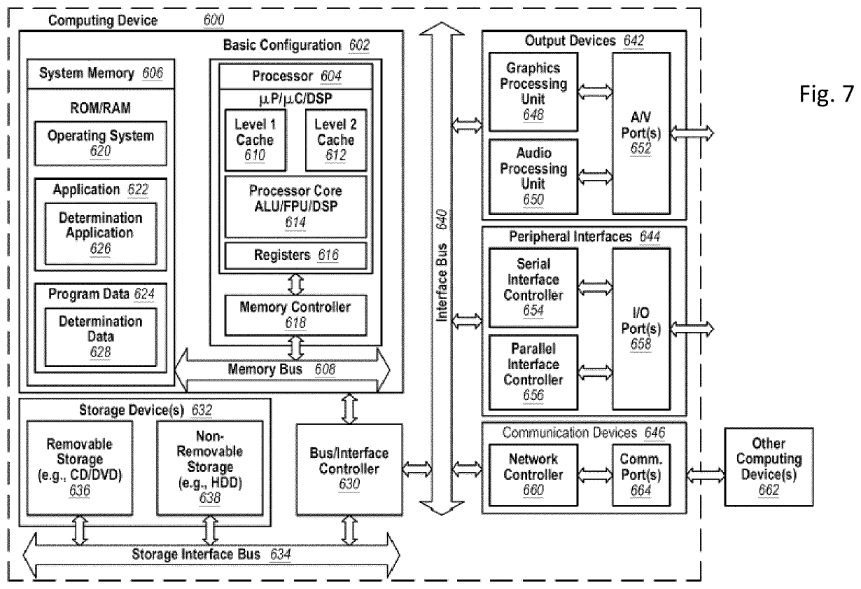

FIG. 7 shows an example computing device 600 (e.g., a computer) that may be arranged in some embodiments to perform the methods (or portions thereof) described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including, but not limited to: a microprocessor (μP), a microcontroller (μC), a digital signal processor (DSP), or any combination thereof. Processor 604 may include one or more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations, memory controller 618 may be an internal part of processor 604.

Depending on the desired configuration, system memory 606 may be of any type including, but not limited to: volatile memory (such as RAM), non-volatile memory (such as ROM, flash memory, etc.), or any combination thereof. System memory 606 may include an operating system 620, one or more applications 622, and program data 624. Application 622 may include a determination application 626 that is arranged to perform the operations as described herein, including those described with respect to methods described herein. The determination application 626 can obtain data, such as pressure, flow rate, and/or temperature, and then determine a change to the system to change the pressure, flow rate, and/or temperature.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include: magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include: volatile and non-volatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to: RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 600 may also be implemented as a personal computer including both laptop computer and non-laptop computer configurations. The computing device 600 can also be any type of network computing device. The computing device 600 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In some embodiments, a computer program product can include a non-transient, tangible memory device having computer-executable instructions that when executed by a processor, cause performance of a method that can include: providing a dataset having object data for an object and condition data for a condition; processing the object data of the dataset to obtain latent object data and latent object-condition data with an object encoder; processing the condition data of the dataset to obtain latent condition data and latent condition-object data with a condition encoder; processing the latent object data and the latent object-condition data to obtain generated object data with an object decoder; processing the latent condition data and latent condition-object data to obtain generated condition data with a condition decoder; comparing the latent object-condition data to the latent-condition data to determine a difference; processing the latent object data and latent condition data and one of the latent object-condition data or latent condition-object data with a discriminator to obtain a discriminator value; selecting a selected object from the generated object data based on the generated object data, generated condition data, and the difference between the latent object-condition data and latent condition-object data; and providing the selected object in a report with a recommendation for validation of a physical form of the object. The non-transient, tangible memory device may also have other executable instructions for any of the methods or method steps described herein. Also, the instructions may be instructions to perform a non-computing task, such as synthesis of a molecule and or an experimental protocol for validating the molecule. Other executable instructions may also be provided.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

All references recited herein are incorporated herein by specific reference in their entirety.

### REFERENCES

This patent application cross-references: U.S. application Ser. No. 16/015,990 filed Jun. 2, 2018; U.S. application Ser. No. 16/134,624 filed Sep. 18, 2018; U.S. application Ser. No. 16/562,373 filed Sep. 5, 2019; U.S. Application No. 62/727,926 filed Sep. 6, 2018; U.S. Application No. 62/746,771 filed Oct. 17, 2018; and U.S. Application No. 62/809,413 filed Feb. 22, 2019; which applications are incorporated herein by specific reference in their entirety. All references recited herein are incorporated herein by specific reference in their entirety.

1. A computer-implemented method of generating objects with a deterministic decoder variational autoencoder (DD-VAE), the method comprising:
providing a model configured as a deterministic decoder variational autoencoder;
inputting object data into a stochastic encoder of the deterministic decoder variational autoencoder;
generating latent codes in the latent space with the encoder;
providing the latent codes from the latent space to a decoder, wherein the decoder is configured as a deterministic decoder;
generating decoded objects with the decoder; and
generating a report that identifies the decoded object.

2. The computer-implemented method of claim 1, comprising:
the encoder mapping the object data onto a distribution of latent codes;
sampling the latent codes in the latent space;
inputting sampled latent codes into the deterministic decoder;
the deterministic decoder mapping each latent code to a single data point; and
generating a distribution of generated objects that are based on the input object data.

3. The computer-implemented method of claim 1, wherein the object data is sequence data.

4. The computer-implemented method of claim 3, wherein the sequence data is simplified molecular-input line-entry system (SMILES) such that the objects are molecules.

5. The computer-implemented method of claim 1, comprising:
obtaining sequence models for the object data being sequence data having sequences;
defining each token of the sequences to be finite;
parameterizing the sequence models as a recurrent neural network for a probability distribution over each token, given latent codes for each previous tokens;
decoding a sequence from the latent codes with the highest score token to produce a reconstructed sequence; and
determining the reconstructed sequence to be a correct sequence.

6. The computer-implemented method of claim 1, comprising:
using a bounded support proposal distribution;
choosing a kernel and computing a Kullback-Leibler divergence;
sampling the latent codes using a rejection sampling;
reparameterizing sampled latent codes to obtain a final sample; and
optionally repeat sampling until obtaining acceptable final samples.

7. The computer-implemented method of claim 6, comprising obtaining a uniform distribution as a prior for the encoder.

8. The computer-implemented method of claim 6, comprising deriving Kullback-Leibler divergence for bounded support distribution for a standard Gaussian distribution and a uniform distribution as a prior for the encoder.

9. The computer-implemented method of claim 1, comprising:
optimizing a discontinuous function by approximating it with a smooth function;
defining an arg max;
approximating the arg max with a smooth relaxation of an indicator function that is parameterized; and
substituting the arg max with the smooth relaxation of the indicator function.

10. The computer-implemented method of claim 1, comprising:
defining arg max equivalently;
introducing a smooth relaxation of an indicator function;
allowing the smooth relaxation to pointwise converge to the indicator function;
substituting arg max with the smooth relaxation; and
obtaining an approximation of an evidence lower bound.

11. The computer-implemented method of claim 1, wherein the sampling is by selecting latent codes using highest scoring tokens.

12. The computer-implemented method of claim 1, comprising:
deriving a Kulback-Leibler divergence against a Gaussian distribution and a uniform distribution; or
computing Kullback-Leibler divergence that encourages latent codes to be marginally distributed as p(z).

13. The computer-implemented method of claim 1, comprising:
i) initialization of a temperature parameter τ to be 0<τ<1;
j) Computing objective function using Eq. (13),
$${ℒ}_{τ} ( θ , ϕ ) = {𝔼}_{x ∼ p ( x )} [ {𝔼}_{z ∼ {q}_{ϕ} ( z \vert x )} {\sum }_{i = 1}^{\vert x \vert} {\sum }_{s \neq {x}_{i}} log {σ}_{τ} ( {π}_{x , i , {x}_{i}}^{θ} ( z ) - {π}_{x , i , s}^{θ} ( z ) ) - 𝒦ℒ ( {q}_{ϕ} ( z \vert x ) \vert \vert p ( z ) ) ] ; \qquad ( 13 )$$
k) compute gradient of the objective function;
l) optimize the outcome of the computed gradient;
m) repeat steps b), c), and d) until convergence;
n) decrease value of temperature parameter τ;
o) repeat steps b), c), d), e) and f) until temperature parameter τ is less than a predefined threshold; and
p) provide trained DD-VAE model.

14. The computer-implemented method of claim 1, comprising:
sampling latent code from a prior distribution;
supplying sampled latent code to a recurrent decoder of the DD-VAE;
obtaining scores for all tokens prior to end of sequence token;
selecting token with highest score;
adding the selected token to end of a current generated sequence;
supplying the sampled token as an input into the recurrent decoder; and
generating an object with the recurrent decoder from the sampled token.

15. The computer-implemented method of claim 1, comprising:
sampling latent code from a prior distribution;
supplying sampled latent code to a decoder of the DD-VAE, wherein the decoder is configured as a convolutional decoder or a fully connected decoder;
simultaneously obtaining scores for each possible value of each output element;
selecting a possible value and highest score for each output element;
supplying the selected output element as an input into the decoder; and
generating an object with the decoder from the selected output element.

16. A method of generating an object, the method comprising:
performing a computer-implemented method:
providing a model configured as a deterministic decoder variational autoencoder;
inputting object data into a stochastic encoder of the deterministic decoder variational autoencoder;
generating latent codes in the latent space with the encoder;
providing the latent codes from the latent space to a decoder, wherein the decoder is configured as a deterministic decoder;
generating decoded objects with the decoder; and
generating a report that identifies the decoded object;
selecting a decoded object; and
obtaining a physical form of the selected decoded object.

17. The method of claim 16, wherein the object is a molecule.

18. The method of claim 17, further comprising validating the molecule to have at least one characteristic of the molecule.

19. A computer system comprising:
one or more processors; and
one or more non-transitory computer readable media storing instructions that in response to being executed by the one or more processors, cause the computer system to perform operations, the operations comprising:
providing a model configured as a deterministic decoder variational autoencoder (DD-VAE);
inputting object data into a stochastic encoder of the deterministic decoder variational autoencoder;
generating latent codes in the latent space with the encoder;
providing the latent codes from the latent space to a decoder, wherein the decoder is configured as a deterministic decoder;
generating decoded objects with the decoder; and
generating a report that identifies the decoded object.

20. The computer system of claim 19, the operations comprising:
the encoder mapping the object data onto a distribution of latent codes;
sampling the latent codes in the latent space
inputting sampled latent codes into the deterministic decoder;
the deterministic decoder mapping each latent code to a single data point; and
generating a distribution of generated objects that are based on the input object data.

21. The computer system of claim 20, wherein the object data is sequence data.

22. The computer system of claim 21, wherein the sequence data is simplified molecular-input line-entry system (SMILES) such that the objects are molecules.

23. The computer system of claim 19, the operations comprising:
obtaining sequence models for the object data being sequence data having sequences;
defining each token of the sequences to be finite;
parameterizing the sequence models as a recurrent neural network for a probability distribution over each token, given latent codes for each previous tokens;
decoding a sequence from the latent codes with the highest score token to produce a reconstructed sequence; and
determining the reconstructed sequence to be a correct sequence.

24. The computer system of claim 19, the operations comprising:
using a bounded support proposal distribution;
choosing a kernel and computing a Kullback-Leibler divergence;
sampling the latent codes using a rejection sampling;
reparameterizing sampled latent codes to obtain a final sample; and
optionally repeat sampling until obtaining acceptable final samples.

25. The computer system of claim 24, the operations comprising obtaining a uniform distribution as a prior for the encoder.

26. The computer system of claim 24, the operations comprising deriving Kullback-Leibler divergence for bounded support distribution for a standard Gaussian distribution and a uniform distribution as a prior for the encoder.

27. The computer system of claim 19, the operations comprising:
optimizing a discontinuous function by approximating it with a smooth function;
defining an arg max;
approximating the arg max with a smooth relaxation of an indicator function that is parameterized; and
substituting the arg max with the smooth relaxation of the indicator function.

28. The computer system of claim 19, the operations comprising:
defining arg max equivalently;
introducing a smooth relaxation of an indicator function;
allowing the smooth relaxation to pointwise converge to the indicator function;
substituting arg max with the smooth relaxation; and
obtaining an approximation of an evidence lower bound.

29. The computer system of claim 19, the operations comprising sampling by selecting latent codes using highest scoring tokens.

30. The computer system of claim 19, the operations comprising:
deriving a Kulback-Leibler divergence against a Gaussian distribution and a uniform distribution; or
computing Kullback-Leibler divergence that encourages latent codes to be marginally distributed as p(z).

31. The computer system of claim 19, comprising:
a) initialization of a temperature parameter τ to be 0<τ<1;
b) Computing objective function using Eq. (13),
$${ℒ}_{τ} ( θ , ϕ ) = {𝔼}_{x ∼ p ( x )} [ {𝔼}_{z ∼ {q}_{ϕ} ( z \vert x )} {\sum }_{i = 1}^{\vert x \vert} {\sum }_{s \neq {x}_{i}} log {σ}_{τ} ( {π}_{x , i , {x}_{i}}^{θ} ( z ) - {π}_{x , i , s}^{θ} ( z ) ) - 𝒦ℒ ( {q}_{ϕ} ( z \vert x ) \vert \vert p ( z ) ) ] ; \qquad ( 13 )$$
c) compute gradient of the objective function;
d) optimize the outcome of the computed gradient;
e) repeat steps b), c), and d) until convergence;
f) decrease value of temperature parameter τ;
g) repeat steps b), c), d), e) and f) until temperature parameter τ is less than a predefined threshold; and
h) provide trained DD-VAE model.

32. The computer system of claim 19, comprising:
sampling latent code from a prior distribution;
supplying sampled latent code to a recurrent decoder of the DD-VAE;
obtaining scores for all tokens prior to end of sequence token;
selecting token with highest score;
adding the selected token to end of a current generated sequence;
supplying the sampled token as an input into the recurrent decoder; and
generating an object with the recurrent decoder from the sampled token.

33. The computer system of claim 19, comprising:
sampling latent code from a prior distribution;
supplying sampled latent code to a decoder of the DD-VAE, wherein the decoder is configured as a convolutional decoder or a fully connected decoder;
simultaneously obtaining scores for each possible value of each output element;
selecting a possible value and highest score for each output element;
supplying the selected output element as an input into the decoder; and
generating an object with the decoder from the selected output element.

34. A method of training a deterministic decoder variational autoencoder (DD-VAE), the method comprising:
a) obtain the deterministic decoder variational autoencoder that has an encoder and a decoder;
b) initialization of a temperature parameter τ to be 0<τ<1;
c) Computing objective function using Eq. (13),
$${ℒ}_{τ} ( θ , ϕ ) = {𝔼}_{x ∼ p ( x )} [ {𝔼}_{z ∼ {q}_{ϕ} ( z \vert x )} {\sum }_{i = 1}^{\vert x \vert} {\sum }_{s \neq {x}_{i}} log {σ}_{τ} ( {π}_{x , i , {x}_{i}}^{θ} ( z ) - {π}_{x , i , s}^{θ} ( z ) ) - 𝒦ℒ ( {q}_{ϕ} ( z \vert x ) \vert \vert p ( z ) ) ] ; \qquad ( 13 )$$
d) compute gradient of the objective function;
e) optimize the outcome of the computed gradient;
f) repeat steps c), d), and e) until convergence;
g) decrease value of temperature parameter τ;
h) repeat steps c), d), e), f) and g) until temperature parameter τ is less than a predefined threshold; and
i) provide trained DD-VAE model.
